(19) United States
(12) Patent Application Publication
(10) Pub. No.: US 2014/0088906 A1
(43) Pub. Date: Mar. 27, 2014

(54) Inertial Sensor Bias Estimation by Flipping

(71) Applicant: John M. Wilson, Hanover, NH (US)

(72) Inventor: John M. Wilson, Hanover, NH (US)

(21) Appl. No.: 13/681,591

(22) Filed: Nov. 20, 2012

Related U.S. Application Data
(60) Provisional application No. 61/705,473, filed on Sep. 25, 2012.

(51) Int. Cl. G01P 21/00; G06F 15/00; G01P 15/18; G01P 15/02

(52) U.S. Cl. CPC G01P 21/00; G01P 15/02; G06F 15/00; G01P 15/18
USPC 702/104; 702/141

(57) ABSTRACT

First and second inertial sensors are arranged in such a manner that their sensitive axes may be made alternately parallel and anti-parallel to one another. Measurements from both inertial sensors are taken during parallel and anti-parallel periods. Measurements from these two periods are used to calculate sensor biases for both sensors. Sensor biases so obtained are used to correct the outputs of the first and second inertial sensors.

### FIELD OF INVENTION

The present invention relates to inertial sensing, in particular determining and compensating for bias errors in inertial sensors.

### BACKGROUND

Numerous prior methods and apparatuses have been attempted for the purpose of estimating inertial sensor biases during operation.

In U.S. Pat. No. 5,194,872, three two-axis rotating-wheel rate gyroscopes are operated in such a manner as to reverse their sensitive axes by physically stopping the rotating mass and reversing its direction of rotation. In this manner, the bias of the gyroscopes can be estimated by comparing pairs of measurements. The orientation of the gyroscopes themselves is not changed, and the method is inapplicable to more modern solid-state inertial sensors such as those in common use today.

In U.S. Pat. No. 7,103,477 and U.S. Pat. No. 7,698,082 bias estimation is achieved by taking advantage of a device-specific ability to reverse the bias of the inertial sensor or its scale factor at will. Such capability is not generally available for the vast majority of inertial sensors in use, and the method is therefore confined to a special case of inertial sensor that is not characteristic of generally available components.

U.S. Pat. No. 7,191,636, U.S. Pat. No. 7,481,109 and U.S. Pat. No. 7,509,857 describe a method to estimate angular rate sensor biases by dithering the sensors about an axis perpendicular to the sensitive axis, using a sinusoidal motion superimposed on a square wave motion, and processing the output of the signals individually to separate bias from the outputs. No utilization of reversal of sensitive axis direction of a sensor is taught, nor is utilization of the outputs of more than a single sensor at a time for bias estimation. Particularly for applications that do not enjoy the benefit of zero cumulative motion over time as in pitch and roll of a marine vessel, the actual ability to extract accurate bias estimates using the method taught is speculative.

In U.S. Pat. No. 7,066,004 and U.S. Pat. No. 7,212,944 a micro-electromechanical (MEM) system is described in which inertial sensors can be rotated with respect to a fixed substrate, and estimation of bias under static conditions only is described by utilizing the outputs of a single sensor rotated 180 deg from its initial orientation. No calculation of bias estimates through simultaneous utilization of the outputs of more than a single sensor is taught, nor is there any way to estimate biases while the system is undergoing motion (i.e. under dynamic rather than static conditions.) A speculation is made that by reversing sensor direction often enough, the cumulative adverse effect of the unknown sensor biases on quantities of interest will average out over time thus diminishing the adverse effects of biases, but this does not equate with an actual ability to identify and subtract biases under dynamic conditions.

### SUMMARY

A substantial problem in utilizing inertial sensors (for example, accelerometers, or angular rate sensors also known as rate gyroscopes) is the problem posed by sensor bias error and bias instability. Those sensors that have lower bias drift, that is greater bias stability, are considered more desirable. They also are more expensive, generally, than those sensors with less bias stability. Bias stability is important for a number of reasons. Among these reasons is the need to integrate inertial sensor output over time to yield such information as attitude (heading, pitch and roll), velocities, and positions. Uncorrected biases integrate over time into very large errors in the integrated quantities. Bias instability is a significant problem for angular rate sensors (also known as rate sensors or rate gyroscopes) as well as for accelerometers.

Inertial sensors (either rate sensors or accelerometers) have defined sensitive axes. If an inertial sensor is “flipped”, that is rotated substantially 180 degrees about an axis substantially perpendicular to its sensitive axis, so that its sensitive axis points in the opposite direction, then it will sense inertial quantities in an opposite sense. However, flipping the inertial sensor does not reverse the directionality of its bias. By taking measurements from pairs of inertial sensors initially aligned with their sensitive axes substantially parallel to one another, and periodically flipping one of the sensors so that its sensitive axis reverses direction thereby making the sensor sensitive axes anti-parallel to one another, it is possible to directly determine the actual bias of both sensors. This is true regardless of what motion profile the object to which the sensors is attached undergoes (so long as the motion profile does not exceed the normal operating range of the sensors, thereby saturating one or more of the sensor outputs.)

The reason that bias may be calculated directly by utilizing measurements from a pair of sensors that are alternately parallel and anti-parallel is as follows. During the period in which the sensors are parallel, their outputs are responsive to the inertial attribute of interest (for example, angular rotation rate, or alternatively acceleration) in a positive sense. However, their outputs are each in error by their own bias at the time of measurement. After one sensor has been reoriented so that the sensitive axes of the two sensors are anti-parallel, the first inertial sensor still is responsive to the inertial attribute of interest in a positive sense, but the second inertial sensor is responsive to the inertial attribute in a negative sense. However, the output of both sensors is still corrupted in the same manner as before by that sensor's bias at the time of measurement.

Because of the characteristic that the effect of the bias on the output of the rotated sensor does not change sign due to its rotation, but the sensitivity of its output to the inertial attribute of interest does change sign, the biases of both sensors become observable and can be calculated directly by using pairs of measurements from the parallel period and from the anti-parallel period.

An inertial measurement apparatus in accordance with the present invention has first and second inertial sensors that produce first and second output signals representative of an inertial attribute to be measured. The first inertial sensor remains fixed in the apparatus while the second sensor is physically rotated so that its sensitive axis is alternately parallel with, and anti-parallel with, the sensitive axis of the first sensor. While it is simplest to have the first inertial sensor fixed and only the second sensor rotatable, any combination of rotation capabilities that achieves the sensitive axes of the two sensors being alternately parallel and anti-parallel can be employed; for simplicity, the discussion below treats the first sensor as being fixed. Measurements taken from the pair of sensors during parallel and anti-parallel periods are used to provide direct determination of bias for both sensors, whether or not the system is undergoing motion. Updated inertial sensor biases are thus made available via direct calculation at regular intervals. The biases so determined, either in raw form or after filtering to reduce noise, are subtracted from the first and second sensor output signals to improve the quality of measurement of the inertial attributes. This provides significant improvement to the functional stability and performance of the inertial sensors, and significantly improved performance from inertial systems utilizing the sensors.

In addition, direct determination of sensor biases on a near-continuous basis enables health monitoring of the inertial sensors in the system, by checking for inordinate and sudden changes in the bias estimates obtained.

Features responsive to temperature and temperature rate of change may be included to adjust the frequency and timing of sensor rotation, the filtering of sensor bias estimates, and the conversion of sensor signals.

Full three-dimensional inertial measurement with bias updates in all three axes of measurement can be obtained by combining three pairs of sensors, where the second member of each pair can be rotated so as to be parallel or anti-parallel to the first sensor, in such an arrangement that all three axes of measurement are sensed by one of the pairs. Redundant sensing and bias estimation can be obtained by utilizing two-axis sensors in place of single-axis sensors for each first sensor in each pair. Further, by utilizing two-axis sensors, a simplified mechanism is possible that still provides full three-dimensional sensing and bias estimation, but that only requires two rotation mechanisms rather than three.

### DESCRIPTION OF THE FIGURES

FIG. 1 is a drawing of an embodiment of an inertial instrument in accordance with the present invention. This embodiment employs a single pair of sensors.

FIG. 2 shows a more detailed functional representation of the embodiment of an inertial instrument that corresponds to that depicted in FIG. 1.

FIG. 3 illustrates the fundamental bias calculation concept using example sensor signals from parallel and anti-parallel periods.

FIG. 4 is a flowchart illustrating the timing of a sequence of computational and control operations suitable to carry out the functions of an inertial instrument in accordance with the present invention.

FIG. 5 is a drawing of an embodiment of an inertial instrument in accordance with the present invention. This embodiment employs a single pair of sensors, each of which has two sensitive axes.

FIG. 6 is a drawing of an embodiment of an inertial instrument in accordance with the present invention. This embodiment employs three pairs of sensors arranged with their first sensitive axes pointing in three orthogonal directions, so as to provide measurements for three dimensions of motion.

FIG. 7 is a drawing of an embodiment of an inertial instrument that is very similar to that of FIG. 6, but in which each sensor has two individual sensor units on it, which may be of different types, for instance an accelerometer and an angular rate sensor.

FIG. 8 is a drawing of an embodiment of an inertial instrument in accordance with the present invention, in which one of the three pairs of sensors of FIG. 6 has been removed. This embodiment provides full three-dimensional sensing with a reduced set of two-axis sensors, and provides bias estimation for all three dimensions during operation with only two rotation mechanisms rather than three.

FIG. 9 shows a more detailed functional representation of an embodiment of an inertial instrument such as illustrated in FIG. 5, FIG. 6, FIG. 7 and FIG. 8, having in addition, sensor measurement averaging, bias filtering and sensor health monitoring.

FIG. 10 is a flowchart illustrating the timing of a sequence of computational and control operations for the inertial instrument shown in the functional block diagram of FIG. 9.

FIG. 11 is a graph illustrating an example output signal sequence from a pair of angular rate sensors, the second of which is made alternately parallel and anti-parallel to the first, and the measurement periods utilized to provide measurements from which inertial sensor biases can be calculated.

FIG. 12 is a graph of computer simulation output showing angular displacement and angular rate for a simulated motion profile.

FIG. 13 is a graph of computer simulation output showing simulated sensor biases over time.

FIG. 14 is a graph of computer simulation output showing simulated instantaneous sensor bias estimates obtained with the method described herein.

FIG. 15 is a pair of graphs of computer simulation output, showing in the first graph simulated angle output obtained by numerically integrating simulated angular rate sensor output without continuing bias compensation, and in the second graph simulated angle output with bias compensation using biases obtained using the disclosed technique.

FIG. 16 is a graph showing temperature versus time of a laboratory experimental prototype of the subject apparatus. Temperature of the apparatus may be important because it may affect bias, scale factor and other important properties of the inertial sensors in the apparatus.

FIG. 17 is a graph showing measured angle output obtained by numerically integrating actual laboratory measurements of angular rate sensor output without compensation using periodically-updated bias estimates.

FIG. 18 is a graph showing measured angle output obtained by numerically integrating actual laboratory measurements of angular rate sensor output with the benefit of compensation using periodically-updated bias estimates obtained using the apparatus and method disclosed herein.

### DETAILED DESCRIPTION

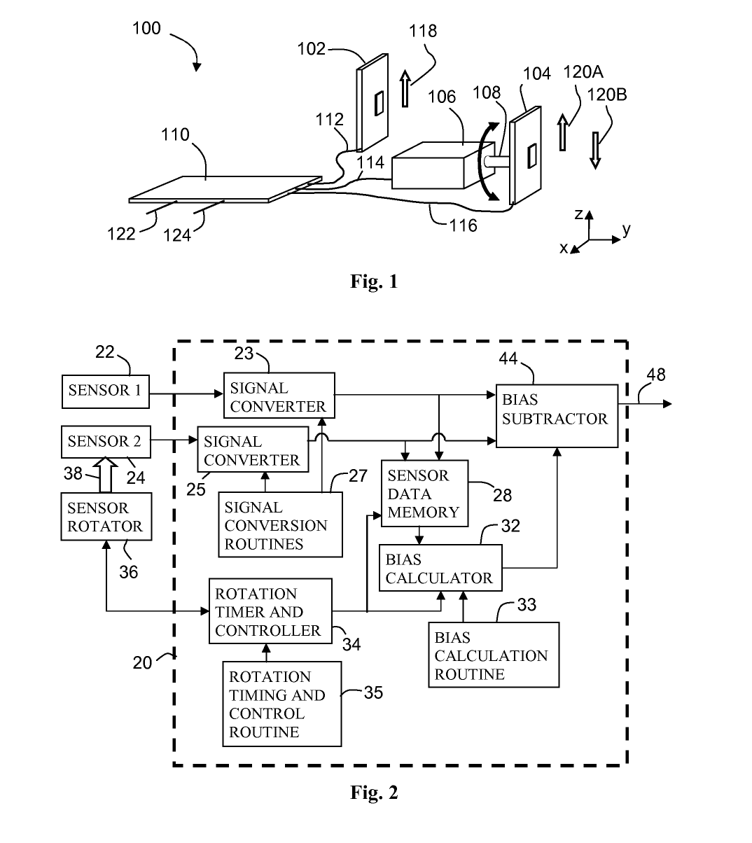

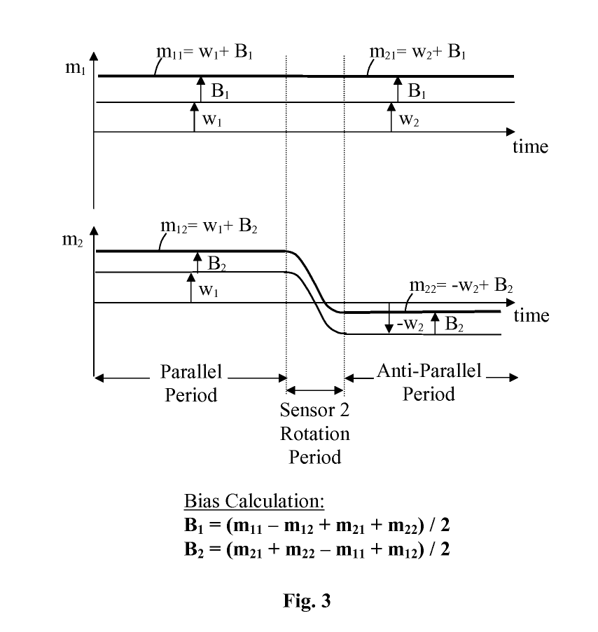

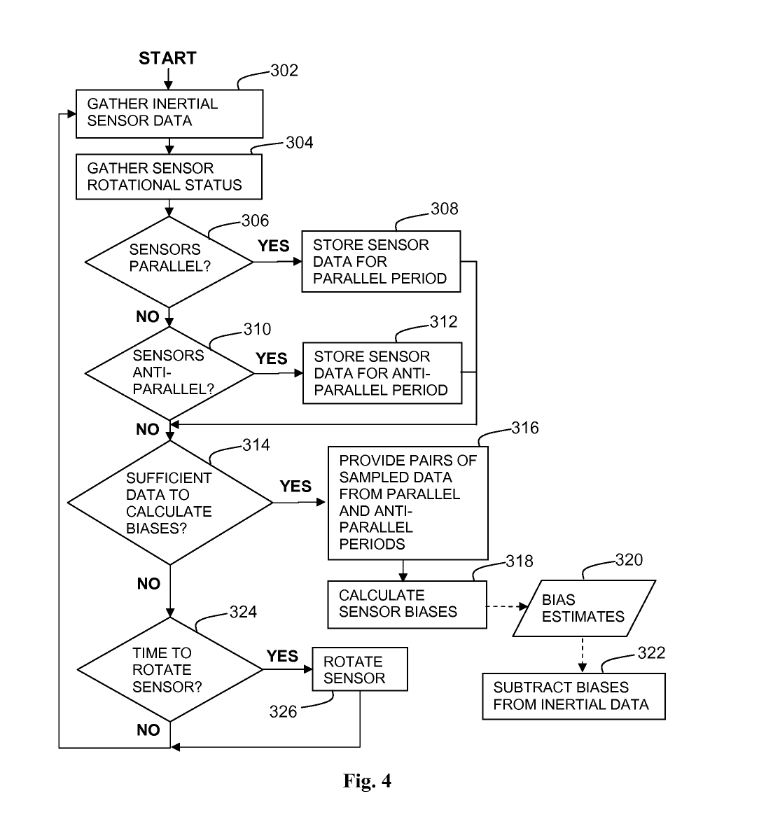

FIG. 1 is a drawing of an embodiment of an inertial instrument in accordance with the present invention. As seen in FIG. 1, an assembly having two inertial sensors is shown as assembly 100. The inertial sensors may be, for example, accelerometers, or angular rate sensors. First inertial sensor 102 is fixed in its nominal orientation, while a second inertial sensor 104 may be rotated by means of rotation mechanism 106 with or without a rotating output shaft 108. Programmable microprocessor/microcontroller 110 includes program and data memory, a microprocessor, and digital and analog input/output capability. Power is provided to microprocessor/microcontroller 110 by power connection 122 and digital data may be transmitted and received via data connection 124. Microprocessor/microcontroller 110 operates under stored program instructions that may be contained initially in its program memory. Operational instructions as well as data are stored in its program and data memory for processing by the microprocessor/microcontroller. Examples of such instruction routines are discussed in connection with FIG. 3 and FIG. 4 below.

Measurements from the inertial sensors 102 and 104 are obtained by microprocessor/microcontroller 110 which also controls the periodic rotation of mechanism 106. Control and data signals are relayed between components by connections 111, 112, 114, and 116, which may include multiple conductors and which may also provide power. As indicated by sensitive direction arrow 118 for sensor 102, and pair of sensitive direction arrows 120A and 120B for sensor 104, sensor 102 has its sensitive axis oriented in a single direction nominally parallel to the z axis in the drawing, while sensor 104 can have the direction of its sensitive axis altered by substantially 180 degrees with respect to that of sensor 102 by means of the rotation imparted by mechanism 106. Thus the sensitive axes of sensor 102 and of sensor 104 may be substantially parallel or anti-parallel to one another, depending upon the control signal sent to mechanism 106 by microprocessor/microcontroller 110. Microprocessor/microcontroller 110 retains in memory all recent inertial measurements from sensor 102 and sensor 104, and the recent rotation state history of mechanism 106, and periodically calculates bias estimates for sensor 102 and sensor 104 using this stored information. The method for periodically calculating the bias estimates takes advantage of pairs of measurements from the two sensors during periods in which their sensitive axes are parallel and anti-parallel, and is discussed in greater detail in connection with FIG. 3. The bias estimates so calculated may be obtained on a periodic basis whether or not the assembly is undergoing motion. As such the bias estimates are of great value, enabling significantly greater accuracy for the outputs of the system 100.

FIG. 2 provides a functional representation of an embodiment of an inertial instrument that corresponds to that depicted in FIG. 1. A first inertial sensor 22 is mounted in a fixed orientation, while a second inertial sensor 24 is mounted so that its sensitive axis can be oriented either substantially parallel or anti-parallel to the sensitive axis of the first sensor. A microprocessor/microcontroller 20 includes numerous functional elements as follows. Signal conversion routines 27 are provided to signal converters 23 and 25 to convert signals from sensor 22 and sensor 24 respectively. The signal conversion routines may optionally provide such corrections as misalignment, scale factor, temperature, coarse bias and acceleration sensitivity corrections. The signal converters may be integrated into the first sensor 22 and second sensor 24, separate from them, or partly integrated and partly separate. Signal converters 23 and 25 send converted signals to sensor data memory 28 and to bias subtractor 44. Rotation timing and control routines 35 are provided to rotation timer and controller 34, which sends rotation commands to sensor rotator 36, which in turn periodically rotates second sensor 24 via physical connection 38. Optionally, sensor rotator 36 reports rotation state back to rotation timer and controller 34. Rotation timer and controller 34 provides information on the rotation state of sensor rotator 36 to sensor data memory 28. Second sensor 24 is thus rotated so that its sensitive axis is either substantially parallel or substantially anti-parallel to that of first sensor 22. Bias calculation routines 33 are provided to bias calculator 32, which utilizes them to produce sensor bias estimates on a periodic basis. The technique employed to determine the bias estimates from the data is discussed below.

The fundamental concept underlying the bias calculation routines is illustrated in FIG. 3. In this figure, example signals obtained from the first and second inertial sensors are shown for parallel and anti-parallel periods, and for a middle period during which the second sensor is rotating from parallel to anti-parallel orientation. The sensor outputs obtained from both sensors are equal to the actual inertial quantity of interest along their sensitive axes, but with a bias error added to that quantity. As seen in FIG. 3, when the orientation of the second sensor changes from being parallel to the first sensor to being anti-parallel, the relationship of its output to that of the first sensor also changes. While its response to the inertial quantity of interest now has opposite sign to when it was parallel to the first sensor, its bias continues to have the same sign in its output. Because of this fact, the four measurements comprised of one measurement from each of the two sensors during the parallel period, and one measurement from each sensor during the anti-parallel period, may be used to solve for the biases of both sensors. This bias calculation, shown in FIG. 3 and described in greater detail in equations Eq1 through Eq16 below, is at the heart of the present invention.

In FIG. 3, the first sensor's output measurement during the parallel period is m₁₁, and is equal to the sum of the inertial attribute of interest during the first period w₁ and the bias of the first sensor B₁. The second sensor's output during the parallel period is m₁₂, and is equal to the sum of the inertial attribute of interest during the first period w₁ and the bias of the second sensor B₂. After the second sensor has completed its rotation from parallel to anti-parallel orientation, the anti-parallel period begins. During the anti-parallel period the first sensor's output measurement is m₂₁, and is equal to the sum of the inertial attribute of interest during the anti-parallel period w₂ and the bias of the first sensor B₁ (which is assumed not to have changed significantly during the short time interval of rotation for the second sensor.) The second sensor's output during the anti-parallel period is m₂₂, and is equal to the sum of the negative of the inertial attribute of interest during the first period −w₁ (since the second sensor's sensitive axis is now oriented in the opposite direction) and the bias of the second sensor B₂. Again the bias of the second sensor B₂ is assumed to not have changed significantly during the short time interval required for the second sensor to change orientation from parallel to anti-parallel. From the four measurements available from the pair of sensors during the parallel and anti-parallel periods, the bias values B₁ and B₂ may be calculated using the mathematical relationships given in FIG. 3. Further formal mathematical discussion of the bias calculation method is given below.

Returning to FIG. 2, bias calculator 32 thus uses uncorrected sensor data from both sensors 22 and 24 stored in sensor data memory 28 and rotation status provided by rotation timer and controller 34 also stored in data memory 28 to periodically calculate instantaneous bias estimates. Bias subtractor 44 subtracts the bias estimates supplied by bias calculator 32 from converted sensor signals available from signal converters 23 and 25 to produce corrected sensor measurements 48.

FIG. 4 is a flowchart illustrating the timing of a sequence of computational and control operations suitable to carry out the functions of the inertial instrument shown in the drawing of FIG. 1 and the functional block diagram of FIG. 2. Inertial measurement data is collected (block 302) from both the first and second inertial sensors. The rotational state of the second inertial sensor, which can be rotated, is gathered (block 304). Rotational state could be determined directly from signals available from a rotation timer and controller such as shown in FIG. 2, but more preferably is obtained directly from a sensor rotator, also shown in FIG. 2. A check is made to determine if the sensitive axes of the two sensors are substantially parallel (decision 306) and if so, sensor inertial data from both sensors is stored for the parallel period (block 308). Another check is made to determine if the sensitive axes of the two sensors are substantially anti-parallel (decision 310) and if so, sensor inertial data from both sensors is stored for the anti-parallel period (block 312). Of course, the sensitive axes cannot be both parallel and anti-parallel at the same time, but the rotating sensor might not yet be fully transitioned from one state to another. A check is made to determine if sufficient data from the parallel and anti-parallel periods are available to calculate biases (decision 314), and if so, pairs of sampled values of inertial outputs for parallel and anti-parallel periods are provided from the two sensors (block 316) and are then used to determine instantaneous bias estimates (block 318) for each sensor. The instantaneous bias estimates are stored (block 320). The bias estimates can then be subtracted from uncorrected inertial measurements to furnish corrected inertial measurements (block 322). Periodically, after a prescribed time has elapsed since the most recent past rotation of the second sensor (block 324), it is rotated by a desired amount (block 326). The amount of rotation is typically 180 degrees positive or negative in the case of single-axis sensors such as those illustrated in the drawing of FIG. 1.

The entire process as described may be carried out on a regular and continuous basis, or from time to time whenever it is desired to obtain updated sensor bias estimates. The prescribed time between rotations is a matter of engineering judgment, but should be short enough to allow fresh bias estimates to be obtained in order to maintain adequate knowledge of biases as they evolve over time. Rotations may be carried out more frequently in cases that bias is anticipated to be changing rapidly, for instance during times when the temperature of the apparatus or the sensors is changing rapidly, and more infrequently when biases are expected to be changing slowly. For example, if biases are expected to be changing significantly within a period of just a few seconds, rotating the second sensor between parallel and anti-parallel states could be desirable once per second or multiple times per second. In contrast, if biases are changing significantly over a period of tens of minutes, then rotating the second sensor between parallel and anti-parallel states might only be necessary once per minute or less.

The biases determined in accordance with the present invention are of great value, because they may be determined on a continuous basis during operation of the apparatus, whether it is undergoing motion or not. Since biases change over time, and the bias changes may not be perfectly predicted by compensation routines such as bias compensation as a function of temperature alone, the ability to directly determine biases regularly enables a much more stable corrected inertial sensor output to be obtained. This has great value for inertial measurement quality, and in particular the quality of outputs derived from inertial measurements, such as integrated angular rates leading to angular orientations, and integrated accelerations leading to velocities and ultimately positions for the purpose of inertial navigation.

It will also be appreciated that the method described may also be carried out while continuously rotating the second inertial sensor, rather than stopping it at strictly parallel and anti-parallel positions, so long as knowledge of when it is parallel and when it is anti-parallel is available. This might be advantageous in certain mechanizations so that the rotation of the sensor does not have to be started and stopped.

A full elucidation of the mathematical relationships underlying the calculation of bias is given later in this description. Additional embodiments of the present invention are now presented.

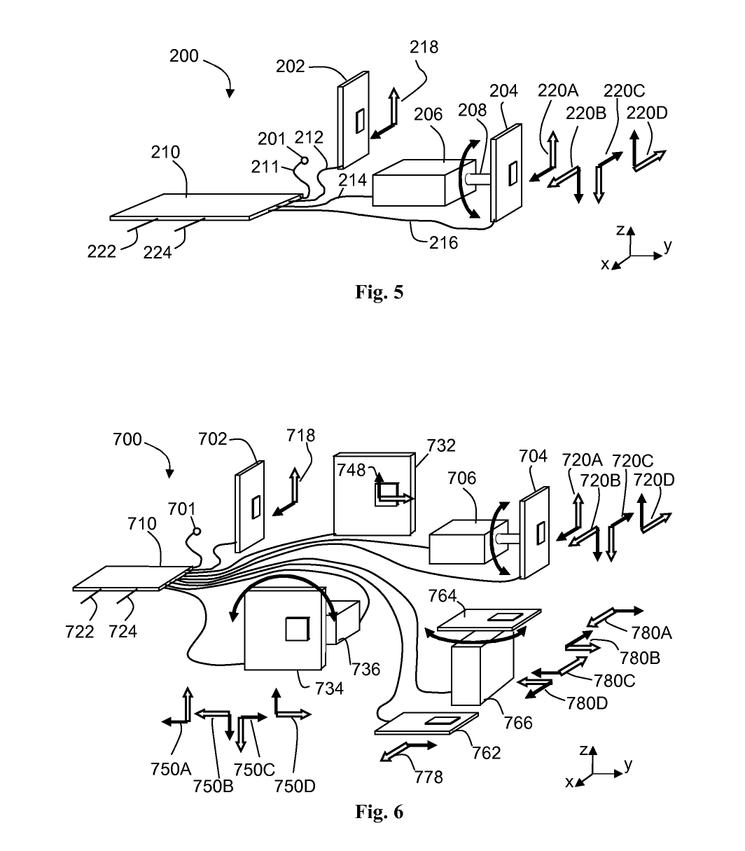

FIG. 5 is a drawing of another embodiment of an inertial instrument in accordance with the present invention, which substitutes sensors with multiple sensitive axes for the single-axis sensors of the initial embodiment of FIG. 1. This has the advantage of providing multiple axes of inertial sensing from a single assembly. As seen in FIG. 5, an assembly having two inertial sensors, in this case two dual-axis sensors, is shown as assembly 200. The inertial sensors may be, for example, accelerometers, or angular rate sensors. Inertial sensor 202 is fixed in its nominal orientation, while a second inertial sensor 204 may be rotated by means of rotation mechanism 206 with or without a rotating output shaft 208. Optionally, temperature sensor 201 provides temperature measurements and is preferably located in close proximity to the first inertial sensor 202. Temperature measurements may be utilized for adjustments within sensor signal conversion routines, for adjusting the frequency of sensor rotation as discussed above, and for adjusting the filtering of calculated biases. When sensor temperature is changing rapidly, sensor bias is more likely to be changing rapidly also. For this reason, the filtering of calculated biases may be adjusted depending upon the rate of change of temperature to yield greater averaging and a more slowly-changing, lower-noise filter output during periods when temperature is not changing rapidly, or less averaging and a more responsive filter output during periods when temperature is changing rapidly. Measurements from the inertial sensors 202 and 204 and optional temperature sensor 201 are obtained by a microprocessor/microcontroller 210, which includes program and data memory, a microprocessor, and digital and analog input/output capability. Power is provided to microprocessor/microcontroller 210 by power connection 222 and digital data may be transmitted and received via data connection 224. Microprocessor/microcontroller 210 operates under stored program instructions that may be contained initially in its program memory. Microprocessor/microcontroller 210 also controls the periodic rotation of mechanism 206. Control and data signals are relayed between components by connections 211, 212, 214, and 216, which may include multiple conductors and which may also provide power.

The directions of the two sensitive axes of sensor 202 are shown by the pair of arrows 218, showing that the two sensitive axes are nominally parallel to the z axis and the x axis in the drawing. The directions of sensitive axes of sensor 204 may assume any of the four orientations shown by the pairs of sensitive axes 220A, 220B, 220C and 220D, where these orientations differ from one another by substantially 90 degrees of rotation as imparted by mechanism 206. In this manner four possible states may be obtained:
(220A) both sensor 202 axes parallel to both sensor 204 axes;
(220B) sensor 202 first sensitive axis (white) anti-parallel to sensor 204 second sensitive axis (black) and sensor 202 second sensitive axis (black) parallel to sensor 204 first sensitive axis (white);
(220C) both sensor 202 axes anti-parallel to both sensor 204 axes;
(220D) sensor 202 first sensitive axis (white) parallel to sensor 204 second sensitive axis (black) and sensor 202 second sensitive axis (black) anti-parallel to sensor 204 first sensitive axis (white).
   Thus each sensitive axis of sensor 202 may be made substantially parallel or substantially anti-parallel to each sensitive axis of sensor 204, depending upon the control signal sent to mechanism 206 by microprocessor/microcontroller 210.

Microprocessor/microcontroller 210 retains in memory all recent inertial measurements from both sensitive axes of sensor 202 and sensor 204, and the rotation state history of mechanism 206, and periodically calculates bias estimates for both sensitive axes of sensor 202 and both sensitive axes of sensor 204 using this stored information. Appropriate bookkeeping using the rotation state history of mechanism 206 is required to properly identify periods of data in which each of the two sensitive axes of sensor 204 are parallel or anti-parallel to each of the two sensitive axes of sensor 202, in order to enable the calculation of biases. It should also be noted that an additional embodiment is represented by the case in which sensor 204 has only a single sensitive axis, in which case that single sensitive axis may be oriented substantially parallel or anti-parallel to each of the two sensitive axes of sensor 202 in turn. A single-axis sensor for sensor 204 could be used in order to provide the same bias estimation capability for both sensitive axes of sensor 202 but at a lower cost.

FIG. 6 is a drawing of an additional embodiment of an inertial instrument in accordance with the present invention. This embodiment employs three pairs of sensors arranged so as to provide inertial sensing in all three axes, and in addition provides redundancy of both sensors and rotation mechanisms. As seen in FIG. 6, an assembly having a plurality of inertial sensors, in this case six dual-axis sensors, is shown as assembly 700. The inertial sensors may be, for example, accelerometers, or angular rate sensors. Inertial sensor 702, inertial sensor 732 and inertial sensor 762 are fixed in their nominal orientations and are arranged so that the first sensitive axes of the three sensors point along mutually orthogonal directions. Inertial sensor 702's first sensitive axis points in the z direction, sensor 732's first sensitive axis in the y direction, and sensor 762's first sensitive axis in the x direction. A fourth sensor 704, fifth sensor 734 and sixth sensor 764 may be rotated by means of rotation mechanisms 706, 736 and 766 respectively, where the axes of rotation of the three rotation mechanisms are substantially orthogonal to one another. Optionally, temperature sensor 701 provides temperature measurements and is preferably located in close proximity to inertial sensor 702. Additional such temperature sensors may be located in close proximity to sensor 732 and sensor 762.

Measurements from the six inertial sensors and the optional temperature sensors are obtained by a programmable microprocessor/microcontroller 710, which includes program and data memory, a microprocessor, and digital and analog input/output capability. Power is provided to microprocessor/microcontroller 710 by power connection 722 and digital data may be transmitted and received via data connection 724. Microprocessor/microcontroller 710 operates under stored program instructions that may be contained initially in its program memory. Microprocessor/microcontroller 710 also controls the periodic rotations of mechanisms 706, 736 and 766. Control and data signals are relayed between components by connections shown, which may include multiple conductors and which may also provide power.

The directions of the two sensitive axes of sensor 702 are shown by the pair of arrows 718, showing that its sensitive axes are nominally parallel to the z axis and the x axis in the drawing. The directions of sensitive axes of sensor 704 may assume any of the four orientations shown by the pairs of sensitive axes 720A, 720B, 720C and 720D, where these orientations differ from one another by substantially 90 degrees of rotation as imparted by mechanism 706, in a manner similar to that described above for the sensors 202 and 204 shown in FIG. 5. Similarly, the directions of the two sensitive axes of sensor 732 are shown by the pair of arrows 748, showing that its sensitive axes are nominally parallel to the y axis and the z axis in the drawing. The directions of sensitive axes of sensor 734 may assume any of the four orientations shown by the pairs of sensitive axes 750A, 750B, 750C and 750D where these orientations differ from one another by substantially 90 degrees of rotation as imparted by mechanism 736. Similarly, the directions of the two sensitive axes of sensor 762 are shown by the pair of arrows 778, showing that its sensitive axes are nominally parallel to the x axis and the y axis in the drawing. The directions of sensitive axes of sensor 764 may assume any of the four orientations shown by the pairs of sensitive axes 780A, 780B, 780C and 780D where these orientations differ from one another by substantially 90 degrees of rotation as imparted by mechanism 766.

In this manner, each sensitive axis of sensor 704 may be made substantially parallel or substantially anti-parallel to each sensitive axis of sensor 702, and also to one each of the two sensitive axes of sensor 732 and of sensor 762. Similarly, each sensitive axis of sensor 734 may be made substantially parallel or substantially anti-parallel to each sensitive axis of sensor 732, and also to one each of the two sensitive axes of sensor 702 and of sensor 762. And in similar fashion, each sensitive axis of sensor 764 may be made substantially parallel or substantially anti-parallel to each sensitive axis of sensor 762, and also to one each of the two sensitive axes of sensor 702 and of sensor 732. Thus multiple combinations are available for pair-wise computation of sensor biases using parallel and anti-parallel periods of measurement. Since the embodiment has sensors with sensitive axes arranged along each of the x, y and z axes, it provides inertial sensing in all three dimensions. Furthermore, each of the three axes has redundant sensing supplied by the combination of sensitive axes provided by the fixed sensors 702, 732 and 762. For example, sensing in the x axis is provided both by the second sensitive axis of sensor 702 (black arrow) and by the first sensitive axis of sensor 762 (white arrow.) Importantly, bias estimation on a periodic basis can continue for sensors in all three dimensions even in the event that one of the three rotation mechanisms fails, providing fault tolerance and fail-operable capability.

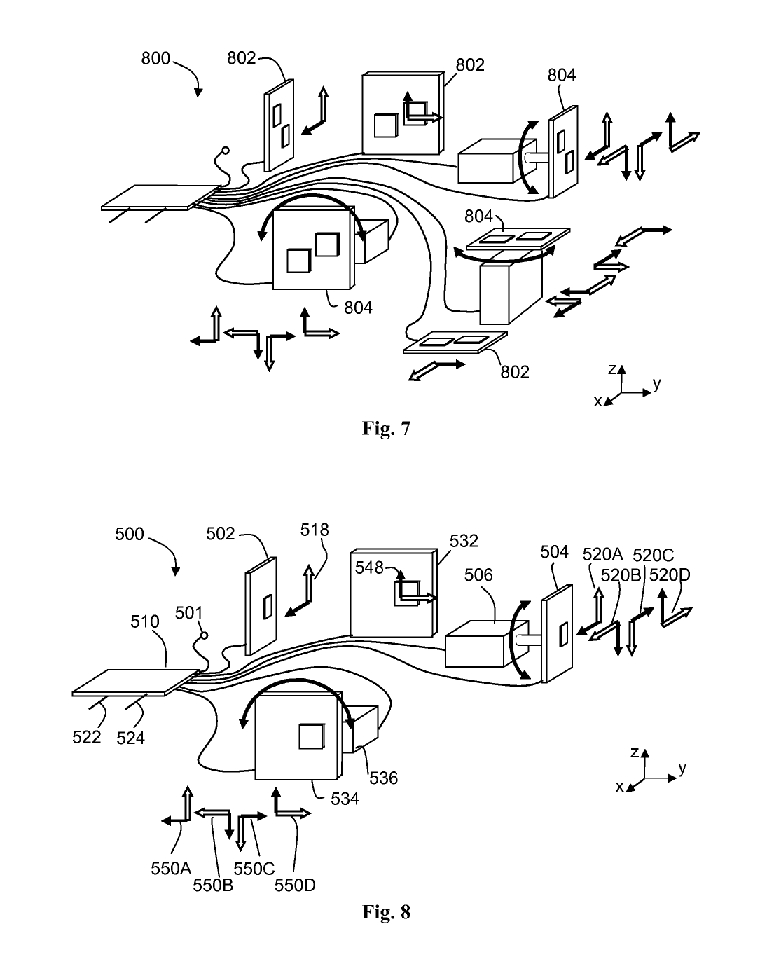

FIG. 7 is a drawing of an embodiment of an inertial instrument that is very similar to that of FIG. 6, but in which each sensor has two individual sensor units on it, which may be of different types, for instance an accelerometer and an angular rate sensor. This embodiment provides inertial sensing in all three axes in similar fashion to the embodiment of FIG. 6. As seen in the figure, assembly 800 has twelve dual-axis sensors. Each of the fixed sensors 802 has two inertial sensing units on it, as does each of the rotating sensors 804. The sensitive axes of the sensing units are as described in connection with the embodiment of FIG. 6. By including two separate inertial sensing units on each sensor, two different types of inertial sensing may be carried out within the same assembly. For instance, the two separate sensing units may be an accelerometer, and an angular rate sensor. In this manner, a full six-degree-of-freedom inertial measurement unit (IMU) may be constructed, providing both angular rates and accelerations, with the ability to estimate biases for all the sensors on a repetitive basis during operation.

FIG. 8 is a drawing of another embodiment of an inertial instrument in accordance with the present invention. In this embodiment, one of the three pairs of fixed and rotating sensors of FIG. 6 has been removed, yet the embodiment still provides sensing including bias estimation in all three dimensions. This embodiment has the advantage of providing this three-dimensional sensing and bias estimation capability but with the use of only two rotating mechanisms, providing a means of cost reduction. As seen in FIG. 8, an assembly having a plurality of inertial sensors, in this case four dual-axis sensors, is shown as assembly 500. The inertial sensors may be, for example, accelerometers, or angular rate sensors. Inertial sensor 502 and inertial sensor 532 are fixed in their nominal orientations and are arranged so that at least one sensitive axis of sensor 532 is substantially orthogonal to the two sensitive axes of sensor 502. A third inertial sensor 504 and a fourth inertial sensor 534 may be rotated by means of rotation mechanisms 506 and 536, respectively, where the axes of rotation of the two rotation mechanisms are substantially orthogonal to one another. Optionally, temperature sensor 501 provides temperature measurements and is preferably located in close proximity to inertial sensor 502. Additional such temperature sensors may be provided, for example located in close proximity to sensor 532.

Measurements from the inertial sensors 502, 532, 504 and 534 and the optional temperature sensors are obtained by a programmable microprocessor/microcontroller 510, which includes program and data memory, a microprocessor, and digital and analog input/output capability. Power is provided to microprocessor/microcontroller 510 by power connection 522 and digital data may be transmitted and received via data connection 524. Microprocessor/microcontroller 510 operates under stored program instructions that may be contained initially in its program memory. Microprocessor/microcontroller 510 also controls the periodic rotations of mechanisms 506 and 536. Control and data signals are relayed between components by connections shown, which may include multiple conductors and which may also provide power. The directions of the two sensitive axes of sensor 502 are shown by the pair of arrows 518, showing that its sensitive axes are nominally parallel to the z axis and the x axis in the drawing. The directions of sensitive axes of sensor 504 may assume any of the four orientations shown by the pairs of sensitive axes 520A, 520B, 520C and 520D, where these orientations differ from one another by substantially 90 degrees of rotation as imparted by mechanism 506. Similarly, the directions of the two sensitive axes of sensor 532 are shown by the pair of arrows 548, showing that its sensitive axes are nominally parallel to the y axis and the z axis in the drawing. The directions of sensitive axes of sensor 534 may assume any of the four orientations shown by the pairs of sensitive axes 550A, 550B, 550C and 550D, where these orientations differ from one another by substantially 90 degrees of rotation as imparted by mechanism 536.

In this manner, each sensitive axis of sensor 504 may be made substantially parallel or substantially anti-parallel to each sensitive axis of sensor 502, and also to one of the two sensitive axes of sensor 532. Similarly, each sensitive axis of sensor 534 may be made substantially parallel or substantially anti-parallel to each sensitive axis of sensor 532, and also to one of the two sensitive axes of sensor 502. Thus multiple combinations are available for pair-wise computation of sensor biases using parallel and anti-parallel periods of measurement. Since the embodiment has sensors with sensitive axes arranged along each of the x, y and z axes, it provides inertial sensing in all three dimensions. It also provides bias estimation for all the sensors in all three axes, and does so with only two rotation mechanisms rather than three, which may be preferable for reasons of simplicity and lower cost.

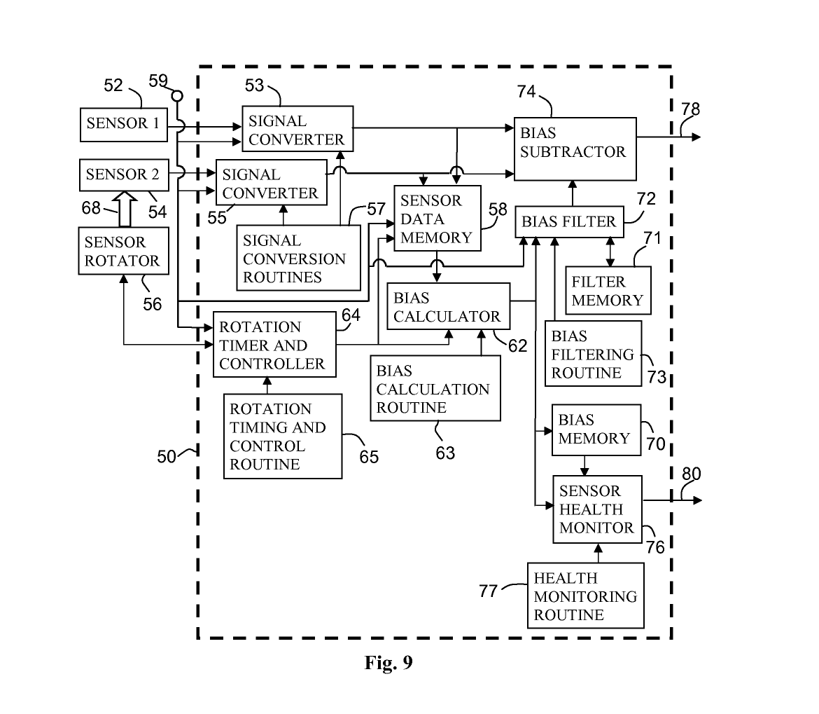

FIG. 9 shows a more detailed functional representation of an embodiment of an inertial instrument such as illustrated in FIG. 5, FIG. 6, FIG. 7 and FIG. 8, having additional sensor measurement averaging, bias filtering and sensor health monitoring features. A first inertial sensor 52 is mounted in a fixed orientation, while a second inertial sensor 54 is mounted so that its sensitive axis can be oriented either substantially parallel or anti-parallel to the sensitive axis of the first sensor. A microprocessor/microcontroller 50 includes numerous functional elements as follows. Signal conversion routines 57 are provided to signal converters 53 and 55 to convert signals from sensor 52 and sensor 54 respectively, including optionally carrying out misalignment, scale factor, temperature compensation, coarse bias corrections and acceleration-sensitivity compensation calculations. Temperature sensor 59 optionally provides temperature information to signal converters 53 and 55, sensor data memory 58, rotation timer and controller 64 and bias filter 72. The signal converters may be integrated into the first and second sensors, separate from them, or partly integrated and partly separate. Signal converters 53 and 55 send converted signals to sensor data memory 58 and to bias subtractor 74. Rotation timing and control routines 65 are provided to rotation timer and controller 64, which sends rotation commands to sensor rotator 56, which in turn periodically rotates second sensor 54 via physical connection 68. Optionally, sensor rotator 56 reports rotation state back to rotation timer and controller 64. Rotation timer and controller 64 provides information on the rotation state of sensor rotator 56 to sensor data memory 58. Second sensor 54 is thus rotated so that its sensitive axis is either substantially parallel or substantially anti-parallel to that of first sensor 52. Bias calculation routines 63 are provided to bias calculator 62. Bias calculator 62 uses uncorrected sensor data from both sensors 52 and 54 stored in sensor data memory 58 and rotation status provided by rotation timer and controller 64 also stored in sensor data memory 58 to periodically calculate instantaneous bias estimates.

The bias estimates are then provided to bias memory 70, bias filter 72 and sensor health monitor 76. Bias filtering routines 73 are provided to bias filter 72, which uses them to process instantaneous bias estimates, storing and retrieving calculated filter states with filter memory 71 and producing filtered bias estimates with reduced noise. Filtering of the instantaneous bias estimates to produce filtered bias estimates has the advantage of reducing noise in the bias estimate used to correct sensor measurements. The filter employed may be any of a number of low-pass filters, and one such filter, a first-order filter, is described in greater detail in connection with equations Eq20 through Eq23 below. Bias subtractor 74 subtracts filtered biases supplied by bias filter 72 from converted sensor signals available from signal converters 53 and 55 to produce corrected sensor measurements 78.

Optionally, health monitoring routines 77 are provided to sensor health monitor 76, which uses them to calculate and output sensor health indicators 80. For example, health monitor 76 checks for sudden shifts in bias indicated by large differences between instantaneous bias estimates and filtered bias estimates that may indicate poor sensor health. If sudden shifts in bias appear that are greater than a certain threshold magnitude, health monitor 76 outputs indicators that the affected sensor is unhealthy. One such method for sensor health monitoring is described in greater detail in connection with equations Eq24 though Eq29 below.

Optionally, corrected sensor measurements 78 may be utilized by bias calculator 62 to identify and eliminate sensor measurements taken during periods of extreme motion (for example, very large angular rates or very large accelerations) from the data used to calculate sensor biases. This had the advantage of avoiding potential inaccuracies in sensor bias estimates arising from errors in knowledge of sensor scale factors.

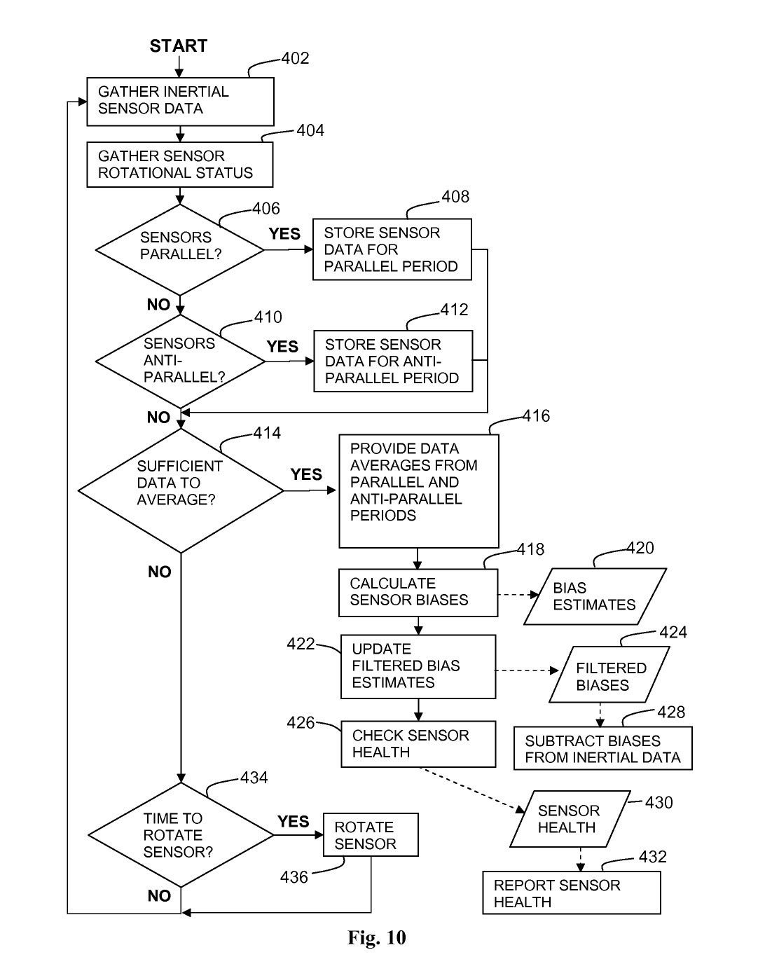

FIG. 10 is a flowchart illustrating the timing of a sequence of computational and control operations for the inertial instrument shown in the functional block diagram of FIG. 9. In addition to the functions exemplified by the previous flowchart of FIG. 4, this shows optional sensor data averaging, optional bias filtering and optional sensor health monitoring capabilities. Inertial measurement data is collected (block 402) from both the first and second inertial sensors. The rotational state of the second inertial sensor, which can be rotated, is gathered (block 404). A check is made to determine if the sensitive axes of the two sensors are substantially parallel (decision 406) and if so, sensor inertial data from both sensors is stored for the parallel period (block 408). Another check is made to determine if the sensitive axes of the two sensors are substantially anti-parallel (decision 410) and if so, sensor inertial data from both sensors is stored for the anti-parallel period (block 412). Of course, the sensitive axes cannot be both parallel and anti-parallel at the same time, but the rotating sensor might not yet be fully transitioned from one state to another. After sufficient time has passed with the sensors parallel and with them anti-parallel so that sufficient data is available to average for bias calculation (decision 414), mean values of inertial outputs for selected periods of time during the parallel and anti-parallel periods are calculated for both sensors and stored (block 416). Data averaging time is a matter of engineering judgment, but should be long enough that sensor noise is averaged sufficiently to provide high-quality averages for bias determination. A sufficient time period for averaging may be as little as a fraction of a second and as long as several minutes. The average values determined for parallel and anti-parallel periods are then used to determine instantaneous bias estimates (block 418) for each sensitive axis and for each sensor. The instantaneous bias estimates are stored (block 420), and are also utilized to update filtered estimates of the biases for each sensitive axis of each sensor (block 422) which are then stored (block 424). The filtered bias estimates can then be subtracted from uncorrected inertial measurements to furnish corrected inertial measurements (block 428).

Optionally, the instantaneous bias estimates and filtered bias estimates may be used to check the health of the inertial sensors as in block 426; for instance, if inertial bias estimates change more rapidly than is characteristic of a normally-functioning inertial sensor, that sensor may be judged to be unhealthy. Block 426 reports sensor health for all sensitive axes of all sensors in the system to block 430. Block 432 then reports sensor health.

Periodically, after a prescribed time has elapsed since the most recent past rotation of the second sensor (block 434), it is rotated by a desired amount (block 436). The amount of rotation is typically 180 degrees positive or negative in the case of single-axis sensors, or in the case of dual-axis sensors, any multiple of 90 degrees positive or negative, i.e. 90, 180 or 270 degrees positive or negative.

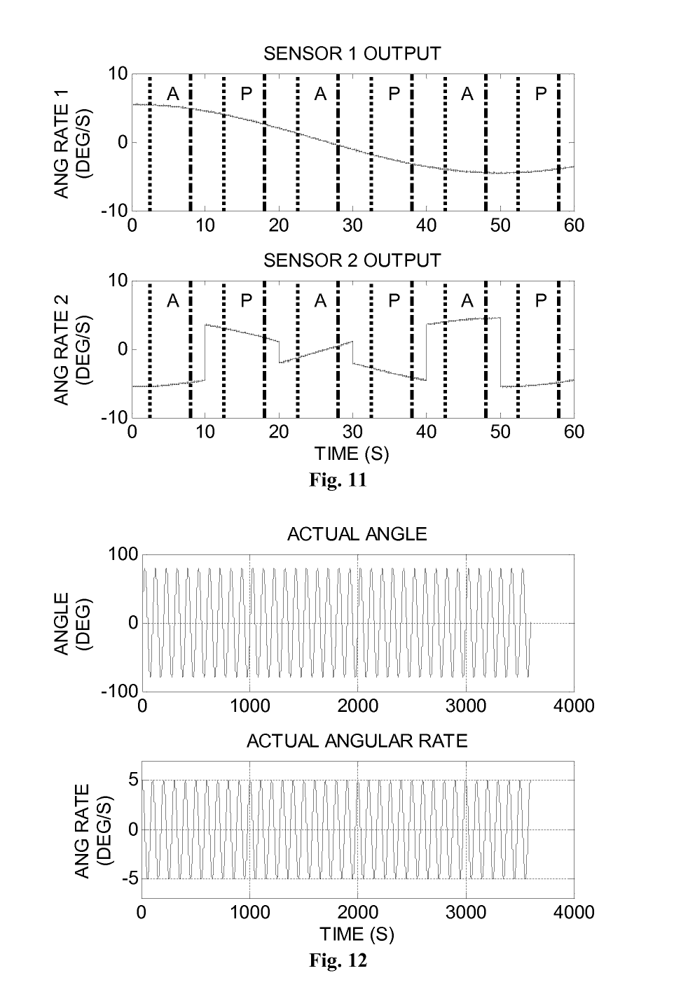

FIG. 11 is a graph illustrating an example output signal sequence from a pair of angular rate sensors, the second of which is made alternately parallel and anti-parallel to the first, and the measurement periods utilized to provide measurements from which inertial sensor biases can be calculated. The output shown in FIG. 11 is illustrative of a case where the body on which the sensors reside is undergoing a slowly-varying sinusoidal motion with a period of 100 seconds and an angular rate amplitude of 5.0 deg/sec. In the case illustrated the second sensor is flipped every 10 seconds. In this example, sensor output data is averaged over the time periods lying between the dotted and dash-dotted vertical bars, labeled “A” for “Anti-Parallel” and “P” for “Parallel”. The averaging is completed once the respective period of time is concluded and sensor measurements for that entire period of time are available. Then the average or mean values for one “A” period and one “P” period are used as shown in equations Eq1 through Eq16 below to determine instantaneous bias estimates for each sensitive axis of each sensor. Optionally, these average or mean values may exclude measurements taken during periods of extreme motion (very high angular rates or very high accelerations, for example) in order to avoid potential errors in bias estimation due to scale factor errors during such extreme motions.

### Mathematical Formulation for Bias Calculations

The following describes a mathematical solution for sensor biases, given measurements from a time period during which the pair of sensors' sensitive axes are parallel, and additional measurements from a time period during which the pair of sensors' sensitive axes are anti-parallel. Mathematical relationships for filtering the biases so determined, and for using them to check sensors health, are also provided.

### Measurements During Parallel Period

The measurements available from sensors 1 and 2 during a parallel period, as illustrated in FIG. 3, are:

m₁₁=w₁+b₁₁ (Eq1)

m₁₂=w₁+b₁₂ (Eq2)

where
w₁=inertial quantity of interest during this period
b₁₁=bias in sensor 1 output during this period
b₁₂=bias in sensor 2 output during this period
m₁₁=measurement from sensor 1 during this period
m₁₂=measurement from sensor 2 during this period
It should be noted that the measurements m₁₁ and m₁₂ may already be corrected for misalignments, scale factor errors, temperature effects, and acceleration sensitivity.

Taking the average or mean values of the measurements over a chosen period of time during the parallel period yields:

M₁₁=W₁+B₁₁ (Eq3)

M₁₂=W₁+B₁₂ (Eq4)

W₁=mean of inertial quantity of interest during this period
B₁₁=mean of bias in sensor 1 output during this period
B₁₂=mean of bias in sensor 2 output during this period
M₁₁=mean of measurements m₁₁ from sensor 1 during this period
M₁₂=mean of measurements m₁₂ from sensor 2 during this period

Without loss of generality, the means so obtained may be taken over a single sample interval and may thus represent a single sample. Alternatively, the means may represent a longer period of data collection and include many samples.

Optionally, the mean values so determined may exclude any measurements occurring while the apparatus is undergoing extreme motion, such as very high angular rates or very high accelerations. Excluding those measurements from the calculation of mean values may minimize bias estimation error due to scale factor uncertainty.

### Measurements During Anti-Parallel “Flipped” Period

The measurements available from sensors 1 and 2 during an anti-parallel period, as illustrated in FIG. 3, are:

m₂₁=w₂+b₂₁ (Eq5)

m₂₂=−w₂+b₂₂ (Eq6)

where
w₂=inertial quantity of interest during this period
b₂₁=bias in sensor 1 output during this period
b₂₂=bias in sensor 2 output during this period
m₂₁=measurement from sensor 1 (or its time-averaged value) during this period
m₂₂=measurement from sensor 2 (or its time-averaged value) during this period
It should be noted that the measurements m₂₁ and m₂₂ may already be corrected for misalignments, scale factor errors, temperature effects, and acceleration sensitivity.

Taking the average or mean values of the measurements over a chosen period of time during the anti-parallel period yields:

M₂₁=W₂+B₂₁ (Eq7)

M₂₂=−W₂+B₂₂ (Eq8)

W₂=mean of inertial quantity of interest during this period
B₂₁=mean of bias in sensor 1 output during this period
B₂₂=mean of bias in sensor 2 output during this period
M₁₂=mean of measurements m₁₁ from sensor 1 during this period
M₂₂=mean of measurements m₁₂ from sensor 2 during this period

Without loss of generality, the means so obtained may be taken over a single sample interval and may thus represent a single sample. Alternatively, the means may represent a longer period of data collection and include many samples.

Optionally, the mean values so determined may exclude any measurements occurring while the apparatus is undergoing extreme motion, such as very high angular rates or very high accelerations. Excluding those measurements from the calculation of mean values may minimize bias estimation error due to scale factor uncertainty.

### Calculation of Sensor Biases

With the parallel and anti-parallel periods being proximate in time, a reasonable assumption can be made that the sensor bias for sensor 1 and for sensor 2 do not change appreciably during the period of interest, so that

B₁=B₂₁=B₁ (Eq9)

B₁₂=B₂₂=B₂ (Eq10)

This allows construction of a system of four equations in four unknowns, where the unknowns are W₁, W₂, B₁ and B₂:

M₁₁=W₁+B₁ (Eq11)

M₁₂=W₁+B₂ (Eq12)

M₂₁=W₂+B₁ (Eq13)

M₂₂=−W₂+B₂ (Eq14)

Solving for the biases B₁ and B₂ yields

B₁=(M₁₁−M₁₂+M₂₁+M₂₂)/2 (Eq15)

B₂=(M₂₁+M₂₂−M+M₁₂)/2 (Eq16)

These bias values B₁ and B₂ may then be used to correct the measurements from the two sensors, in the following manner:

w₁_{_{—}}_{CORR}=m₁−B₁ (Eq17)

for all periods,
and

w₂_{_{—}}_{CORR}=m₂−B₂ (Eq18)

during parallel periods, or

w₂_{_{—}}_{CORR}=−m₂−B₂ (Eq19)

during anti-parallel periods,
where
m₁=measurement from sensor 1
m₂=measurement from sensor 2
w₁_{_{—}}_{CORR}=bias-corrected measurement from sensor 1
w₂_{_{—}}_{CORR}=bias-corrected measurement from sensor 2

### Filtering of Sensor Biases

Furthermore, the bias values so calculated may be considered instantaneous values and may be used as inputs to a filtered representation of bias so as to continuously update a filtered bias estimate, which may then be used to correct the measurements from the two sensors. One such filter is a first-order filter, wherein filter coefficients are calculated as

k₀=e^{-Δt/τ} (Eq20)

k₁=1−k₀ (Eq21)

where
Δt=a typical time period between updates to the filter
τ=time constant
and the filter is implemented as

B₁_{_{—}}_{FILT}_{_{—}}_{NEW}=k₀×B₁_{_{—}}_{FILT}_{_{—}}_{OLD}+k₁×B₁ (Eq22)

B₂_{_{—}}_{FILT}_{_{—}}_{NEW}=k₀×B₂_{_{—}}_{FILT}_{_{—}}_{OLD}+k₁×B₂ (Eq23)

where
B₁_{_{—}}_{FILT}_{_{—}}_{NEW}=new filtered estimate of B₁
B₁_{_{—}}_{FILT}_{_{—}}_{OLD}=previous filtered estimate of B₁
B₁=new instantaneous value of B₁
B₂_{_{—}}_{FILT}_{_{—}}_{NEW}=new filtered estimate of B₂
B₂_{_{—}}_{FILT}_{_{—}}_{OLD}=previous filtered estimate of B₂
B₂=new instantaneous value of B₂

In this case, the values B₁_{_{—}}_{FILT}_{_{—}}_{NEW} and B₂_{_{—}}_{FILT}_{_{—}}_{NEW} may be substituted for B₁ and B₂ respectively in equations Eq17, Eq18 and Eq19 to determine corrected measurements from sensor 1 and sensor 2.

The value of Δt should be substantially equal to the typical time interval between availability of newly-computed instantaneous bias values. The value of τ should be chosen in such a manner to provide adequate suppression of noise in the instantaneous calculated bias values without injecting unacceptable filter lag, as one practiced in the art will realize. The value of τ may also be adjusted continuously or in discrete steps to achieve best bias estimation performance, depending on the characteristics of the sensors and system. Other filter formulations are possible and may be advantageous including higher-order filters.

### Sensor Health Monitoring

Sensor bias estimate values can be used to indicate the health of a sensor. In particular, the difference between an instantaneous sensor bias and the filtered sensor bias may be used to detect an unhealthy sensor. For instance, differences between the instantaneous bias estimates and the filtered bias estimates may be calculated as

B₁_{_{—}}_{DIFF}=|B₁−B₁_{_{—}}_{FILT}_{_{—}}_{OLD}| (Eq24)

B₂_{_{—}}_{DIFF}=|B₂−B₂_{_{—}}_{FILT}_{_{—}}_{OLD}| (Eq25)

where
B₁_{_{—}}_{DIFF}=sensor 1 absolute value of difference between instantaneous and filtered bias
B₂_{_{—}}_{DIFF}=sensor 2 absolute value of difference between instantaneous and filtered bias

If the magnitude of the difference exceeds a certain threshold, where the threshold is a value that is characteristic of the outer boundaries of the sensor's normal behavior, then that sensor may be declared unhealthy.

H₁=1 if B₁_{_{—}}_{DIFF}≦B₁_{_{—}}_{DIFF}_{_{—}}_{MAX} (Eq26)

H₁=0 if B₁_{_{—}}_{DIFF}>B₁_{_{—}}_{DIFF}_{_{—}}_{MAX} (Eq27)

H₂=1 if B₂_{_{—}}_{DIFF}≦B₂_{_{—}}_{DIFF}_{_{—}}_{MAX} (Eq28)

H₂=0 if B₂_{_{—}}_{DIFF}<B₂_{_{—}}_{DIFF}_{_{—}}_{MAX} (Eq29)

where
H₁=sensor 1 health indicator (1=healthy, 0=unhealthy)
H₂=sensor 2 health indicator (1=healthy, 0=unhealthy)
B₁_{_{—}}_{DIFF}_{_{—}}_{MAX}=sensor 1 bias difference threshold
B₂_{_{—}}_{DIFF}_{_{—}}_{MAX}=sensor 2 bias difference threshold

### Simulation Results

Computer simulation results are presented which are illustrative of the invention. The simulation results shown happen to be for angular rate sensors (without restricting applicability to accelerometers or other inertial sensors.) In this simulation case, angular rate sensors with bias instability resulting in integrated angular rate, uncompensated, of approximately 250 deg/hr are simulated. In addition, the sensors have Gaussian random noise of 0.05 deg/sec, 1 sigma. Nothing in the technique restricts its use to pairs of sensors having equivalent bias or noise properties. It is also effective to use a lesser-quality sensor paired with a higher-quality sensor to continuously estimate biases of both.

In the case simulated, an example sinusoidal input of 5 deg/sec amplitude and period of 100 sec is imposed on the object to which the angular rate sensors are attached, along an axis parallel to the first sensor's sensitive axis. This motion is not necessary to the technique, but is provided in this example to demonstrate applicability and effectiveness even when an object to which the invention is attached is itself undergoing motion. The second sensor undergoes a flip once per second (though this period may be adjusted to any reasonable value that is much less than the characteristic time of bias drift.) Motion is simulated to continue for 1 hour in this manner.

The resulting actual angular displacement of the object and the actual angular rate are shown in FIG. 12.

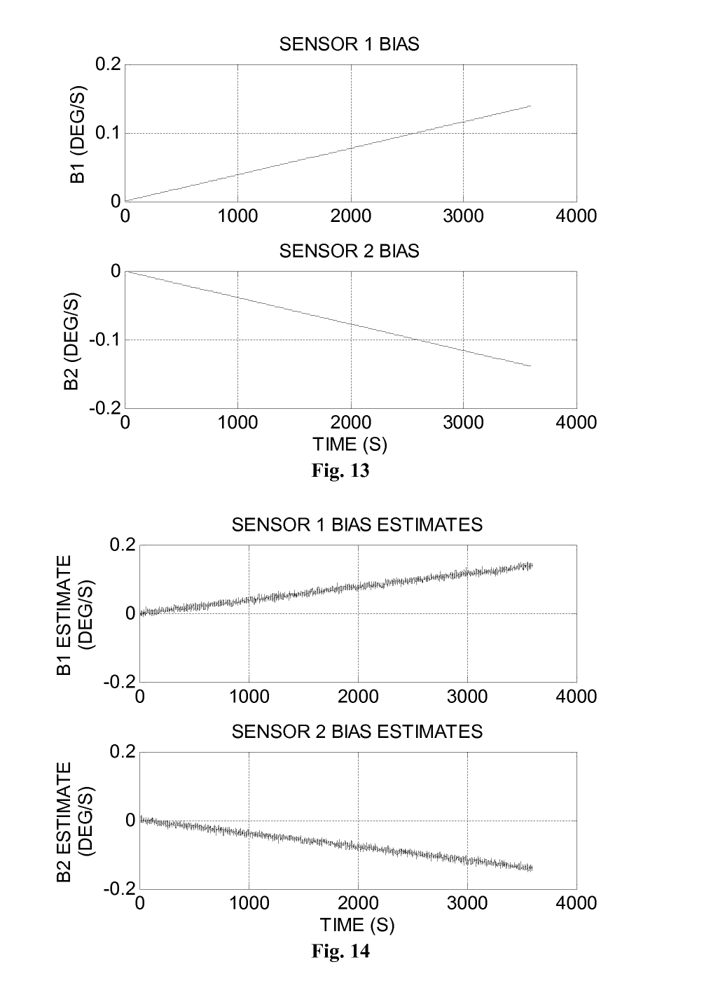

FIG. 13 is a graph of computer simulation output showing simulated sensor biases over time. The algorithm produces excellent instantaneous estimates of these sensor biases, as seen in FIG. 14. The instantaneous bias estimates exhibit noise as expected, since the sensor measurements themselves have inherent noise. It will be obvious to those practiced in the art that filtering may be used to refine the instantaneous bias estimates.

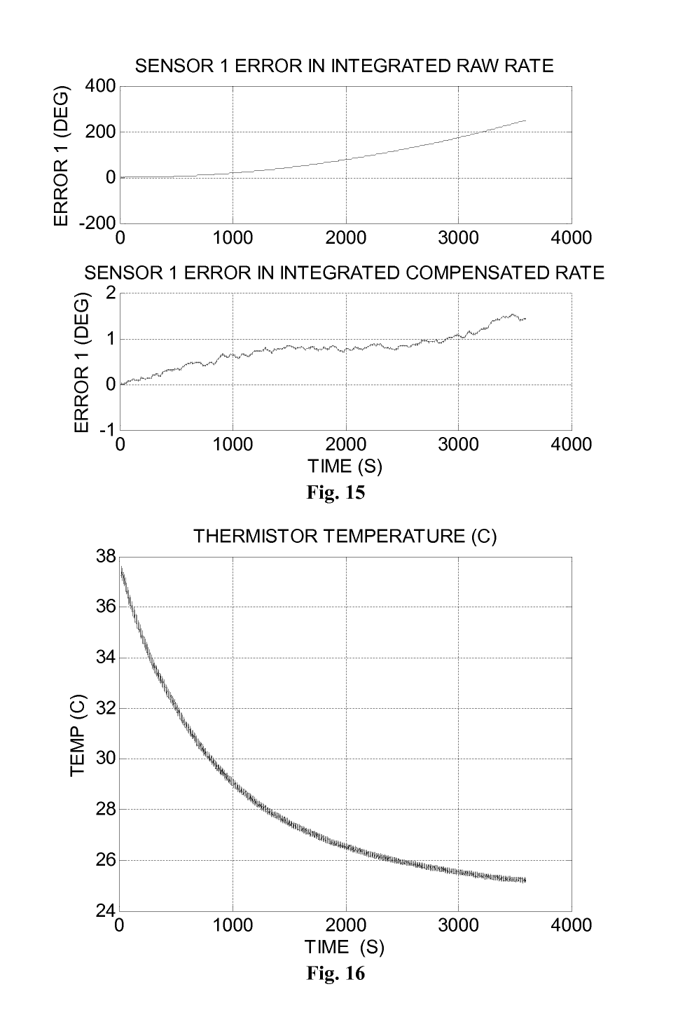

In FIG. 15, the effect of subtracting sensor 1's bias estimate obtained from the procedure described herein is seen. The top plot of FIG. 15 shows the accumulated angular error resulting from integration of the first sensor's output, with its unstable bias, over the course of 1 hour's time. The angular error resulting is in excess of 250 deg in this case. The bottom plot shows the angular error resulting from integrating the first sensor's output after subtracting the bias estimated using the technique described herein. The dramatic improvement is seen, wherein the error in the resulting integrated angle is less than 2.0 deg after 1 hour's time.

### Laboratory Prototype Data

In one embodiment of the invention tested in a laboratory environment, a pair of Systron Donner HZ1-90-100A angular rate sensors are used as the inertial sensors. For this laboratory test, the system is not undergoing externally-applied motion but is sitting still on the laboratory bench; nevertheless, the results are illustrative of the performance to be anticipated even if external motion is present. The sensitive direction of the second sensor is changed from parallel to anti-parallel, or back from anti-parallel to parallel, at time intervals of 10.0 sec. The mechanism to flip the second sensor requires approximately 0.8 sec to complete the reorientation of the sensor. For the purposes of calculating instantaneous bias estimates, sensor data are averaged beginning 1.8 sec after commencement of the reorientation motion, and ending 9.3 sec after the commencement, for an averaging period of 7.5 sec. A first-order low-pass filter is utilized to achieve filtered bias estimates for both sensors from the instantaneous bias estimates. The time constant for the filter is 30.0 sec in steady state, where steady state begins after 180 sec of operation. Prior to steady state filtering, earlier filter stage lengths and time constants are: stage 1 for 30.0 sec with time constant of 5.0 sec; stage 2 for 60.0 sec with time constant of 10.0 sec; and stage 3 for 90.0 sec with time constant of 20.0 sec.

In the laboratory data shown, the temperature of the entire system is being gradually changed, in order to demonstrate the effects of typical operational thermal variation on performance. For reference, FIG. 16 shows the temperature of the apparatus versus time, obtained from a thermistor on the microprocessor/microcontroller during the hour of data collection. Prior to utilizing the angular rate outputs of the sensors, temperature compensation is carried out utilizing a first-order fit of bias versus temperature for both sensors, obtained from earlier thermal characterization.

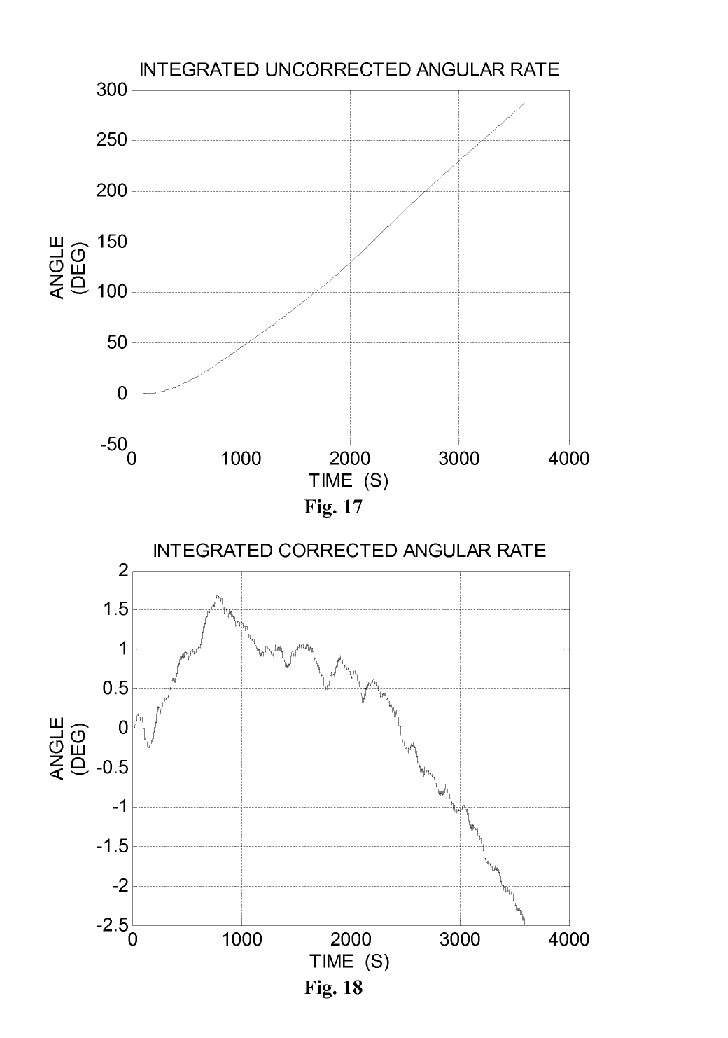

Shown in FIG. 17 is integrated angular rate from the first sensor utilizing temperature compensation only and subtracting an initial bias obtained from averaging the first 60.0 sec of the sensor's output. In contrast, FIG. 18 shows the integrated angular rate from the first sensor with temperature compensation, and further correction by subtraction of the filtered bias estimate obtained using the system and method disclosed herein. As seen in FIG. 17, the temperature-compensated performance of the rate sensor exhibits drift of over 250 degrees in one hour's time. By contrast, the performance of the rate sensor utilizing the bias estimates obtained by the disclosed system and method exhibits drift of less than 3.0 degrees over the same period of one hour, as seen in FIG. 18.

### OPERATION

While the inertial system is being utilized, the biases from inertial sensors are determined on a periodic basis by utilizing the method described herein. The biases so determined, or filtered versions of them, can then be used to correct outputs from the inertial sensors, thereby greatly improving the quality of results determined by using those outputs. Furthermore, the health of the sensors may be determined by monitoring for uncharacteristic or rapid changes in the calculated bias of any of the sensors, and a health status for each sensor reported.

The system disclosed herein may be combined in a multiplicity of copies arranged in such a manner as to comprise a three-axis rate sensor, a three-axis accelerometer, or a complete six-degree-of-freedom inertial measurement unit (IMU). In so doing, three rotating mechanisms may be provided, or alternatively two rotating mechanisms rather than three may be provided and are sufficient to enable continuous bias estimation for all three axes of the IMU. Multiple sensors may also be used in either the fixed or rotated positions to improve the noise properties or redundancy of the inertial measurement system.

While the novel features of the present invention have been described in terms of particular embodiments and preferred applications, it should be appreciated by one skilled in the art that substitution of materials and modification of details can be made without departing from the spirit of the invention.

I claim:

1. A system for estimating the bias of inertial sensors, comprising:
a first inertial sensor having a first sensor sensitive axis;
a second inertial sensor having a second sensor sensitive axis;
a mechanism for physically rotating said second inertial sensor so as to align its said second sensor sensitive axis either substantially parallel or anti-parallel to said first sensor sensitive axis;
a sensor signal converter to convert signals from said first and second inertial sensors;
a sensor data memory to store said converted signals from said first and second inertial sensors; and
an electronic data processor to calculate sensor biases of said first and second inertial sensors based on said converted signals stored during periods in which said first sensor and second sensor sensitive axes are parallel and periods in which said first sensor and second sensor sensitive axes are anti-parallel.

2. The system of claim 1 further comprising a bias subtractor to compensate sensor outputs by subtracting the biases so determined from the measurements indicated by the sensor signals.

3. The system of claim 2 further comprising:
a filter memory for storing and retrieving calculated bias filter states; and
a noise-reduction bias filter to filter the most recent calculated bias estimate using the recorded bias filter states in said filter memory in order to reduce noise in the bias estimate employed by said bias subtractor.

4. The system of claim 2 further comprising:
a bias memory for recording the calculated sensor biases;
a prescribed bias comparison standard; and
a sensor health monitoring routine for instructing said electronic data processor to compare recently-determined bias estimates to previously stored bias estimate values recorded in said bias memory to determine whether the conditions of said prescribed bias comparison standard are met and, if not met, providing a sensor health warning.

5. The system of claim 2 further comprising:
a temperature sensor;
a temperature memory for recording signals from said temperature sensor;
a temperature change monitoring routine for instructing said electronic data processor to determine a rate of temperature change from the temperatures indicated by the signal values recorded in said temperature memory;
a rotation timer and controller operated by said electronic data processor to control operation of said second sensor rotating mechanism to set the duration of the parallel and anti-parallel periods; and
a timing adjustment routine instructing said electronic data processor to adjust the duration of said periods responsive to said determined rate of temperature change.

6. The system of claim 1 in which one or more of the inertial sensors are sensitive in multiple axes.

7. The system of claim 1 further comprising:
a third inertial sensor having a third sensor sensitive axis that is oriented orthogonally to said first sensor sensitive axis;
a fourth inertial sensor having a fourth sensor sensitive axis;
a fourth sensor rotating mechanism for physically rotating said fourth inertial sensor about an axis orthogonal to that about which said second inertial sensor rotates so as to align said fourth sensor sensitive axis either substantially parallel or anti-parallel to said third sensor sensitive axis;
further wherein said sensor signal converter also converts signals from said third and fourth inertial sensors and said sensor data memory includes locations to store said converted signals from said third and fourth inertial sensors; and
further wherein said electronic data processor calculates sensor biases of said third and fourth inertial sensors based on said converted signals collected from these sensors and stored during periods in which said third and fourth sensitive axes are parallel and periods in which said third and fourth sensitive axes are anti-parallel.

8. The system of claim 7 further comprising:
a fifth inertial sensor having a fifth sensor sensitive axis that is oriented orthogonally to both said first sensor sensitive axis and said third sensor sensitive axis;
a sixth inertial sensor having a sixth sensor sensitive axis;
a sixth sensor rotating mechanism for physically rotating said sixth inertial sensor about an axis orthogonal to that about which said second inertial sensor rotates and to that about which said fourth inertial sensor rotates, so as to align said sixth sensor sensitive axis either substantially parallel or anti-parallel to said fifth sensor sensitive axis;
further wherein said sensor signal converter also converts signals from said fifth and sixth inertial sensors and said sensor data memory includes locations to store said converted signals from said fifth and sixth inertial sensors; and
further wherein said electronic data processor calculates sensor biases of said fifth and sixth inertial sensors based on said converted signals collected from these sensors and stored during periods in which said fifth and sixth sensitive axes are parallel and periods in which said fifth and sixth sensitive axes are anti-parallel.

9. A system for estimating the bias of inertial sensors, comprising:
a first pair of inertial sensors having,
a first inertial sensor having a first sensor first sensitive axis and a first sensor second sensitive axis that is substantially normal to said first sensor first sensitive axis,
a second inertial sensor having a second sensor sensitive axis, and
a second sensor rotating mechanism for physically rotating said second inertial sensor about a first pair axis so as to align said second sensor sensitive axis in turn either substantially parallel or anti-parallel to said first sensor first sensitive axis and said first sensor second sensitive axis;
a second pair of inertial sensors having,
a third inertial sensor having a third sensor third sensitive axis and a third sensor second sensitive axis that is substantially normal to said third sensor first sensitive axis,
a fourth inertial sensor having a fourth sensor sensitive axis, and
a fourth sensor rotating mechanism for physically rotating said fourth inertial sensor about a second pair axis that is substantially orthogonal to said first pair axis, so as to align said fourth sensor sensitive axis in turn either substantially parallel or anti-parallel to said third sensor first sensitive axis and said third sensor second sensitive axis;
a sensor signal converter to convert signals from said inertial sensors;
a sensor data memory to store said converted signals from said inertial sensors; and
an electronic data processor to calculate sensor biases of said inertial sensors of each of said pairs based on said converted signals collected and stored during periods,
when said second sensor sensitive axis is substantially parallel to said first sensor first sensitive axis and when said second sensor sensitive axis is substantially anti-parallel to said first sensor first sensitive axis,
when said second sensor sensitive axis is substantially parallel to said first sensor second sensitive axis and when said second sensor sensitive axis is substantially anti-parallel to said first sensor second sensitive axis,
when said fourth sensor sensitive axis is substantially parallel to said third sensor first sensitive axis and when said fourth sensor sensitive axis is substantially anti-parallel to said third sensor first sensitive axis, and
when said fourth sensor sensitive axis is substantially parallel to said third sensor second sensitive axis and when said fourth sensor sensitive axis is substantially anti-parallel to said third sensor second sensitive axis.

10. The system of claim 9 further comprising a bias subtractor to compensate sensor outputs by subtracting the biases so determined from the measurements indicated by the sensor signals.

11. The system of claim 10 in which the said first, second, third and fourth inertial sensors are each comprised of more than one inertial sensor unit, and in which the different inertial sensor units measure different inertial attributes, for example acceleration and angular rate.

12. A method for estimating the bias in inertial sensors, comprising the steps of:
providing output signals from at least one pair of inertial sensors during a period in which the sensitive axes of the pair are parallel;
rotating one of the sensors in the pair to a position in which the sensitive axes of the pair are anti-parallel to one another;
providing output signals from the pair of inertial sensors during a period in which the sensitive axes of the pair are anti-parallel; and
calculating sensor biases from the output signals provided from the pair of sensors during said parallel and anti-parallel periods.

13. The method of claim 12 further including the step of compensating sensor outputs by subtracting sensor biases so determined from the sensor output signals.

14. The method of claim 12 further including the step of averaging multiple measurements during parallel and anti-parallel periods prior to their use in calculation of bias estimates.

15. The method of claim 14 further including the steps of:
prescribing a maximum magnitude of sensor output; and
eliminating sensor outputs whose magnitude exceeds said prescribed maximum magnitude from the data used to calculate sensor biases.

16. The method of claim 13 further including the step of utilizing a noise-reduction filter to filter the bias estimates obtained to reduce noise.

17. The method of claim 16 further including the steps of:
monitoring temperature; and
adjusting the bias filtering in a manner responsive to temperature and rate of change of temperature.

18. The method of claim 13 further including the steps of:
prescribing a bias comparison standard; and
comparing instantaneous bias estimates with a stored history of bias estimates to determine whether the conditions of said prescribed bias comparison standard are met and, if not met, providing a sensor health warning.

19. The method of claim 12 further including the steps of:
monitoring temperature; and
adjusting the timing of sensor rotations in a manner responsive to temperature and rate of change of temperature.
